(19) United States
(12) Patent Application Publication
(10) Pub. No.: US 2016/0179910 A1
(43) Pub. Date: Jun. 23, 2016

(54) METHOD AND SYSTEM FOR INTERACTIVE GEOMETRIC REPRESENTATION, USE AND DECISIONING OF SYSTEMIC EPIDEMIOLOGICAL DATA

(71) Applicant: SHARADA KALANIDHI KARMARKAR, Palo Alto, CA (US)

(72) Inventor: SHARADA KALANIDHI KARMARKAR, Palo Alto, CA (US)

(21) Appl. No.: 14/791,475

(22) Filed: Jul. 5, 2015

Related U.S. Application Data
(63) Continuation-in-part of application No. 13/715,795, filed on Dec. 14, 2012, now abandoned.

(51) Int. Cl. G06F 17/30

(52) U.S. Cl. CPC G06F 17/30554

(57) ABSTRACT

In one exemplary embodiment, a computer-implemented method includes obtaining a data set from a data source. The data set is prepared for an analysis operation according to a problem type. A result is generated from an interactive geometric node based a geometric property of the data set. A specified condition with the result from the interactive geometric node is determined based on a query to the interactive geometric node. Optionally, the data set can be a digital interaction data. The data set can be biometric data from a biosensor. The data set comprises a previous result of another interactive geometric node. The results from the interactive geometric node can be a geometric representation, a geometric computation or a geometric decision.

### CROSS-REFERENCE TO RELATED APPLICATIONS

This application is a claims priority to U.S. patent application Ser. No. 13/715,795 titled METHOD AND SYSTEM FOR INTERACTIVE GEOMETRIC REPRESENTATIONS, USE AND DECISIONING OF DATA filed on Dec. 14, 2012. This application is hereby incorporated by reference in their entirety.

### BACKGROUND

1. Field

This application relates generally to data analysis and use, and more specifically to a system and method of interactive geometric representation, use and decisioning of systemic epidemiological data.

2. Related Art

Conventional methods of analyzing data may be ineffective for datasets with a certain volume and dimensionality. Indeed, these twin simultaneous problems—volume and geometric attributes such as dimensionality—may manifest themselves as problems when one tries to analyze volumes of data using conventional techniques. Thus, improved methods and systems of data analysis and decisioning are desired.

### BRIEF SUMMARY OF THE INVENTION

In one exemplary embodiment, a computer-implemented method includes obtaining a data set from a data source. The data set is prepared for an analysis operation according to a problem type. A result is generated from an interactive geometric node based a geometric property of the data set. A specified condition with the result from the interactive geometric node is determined based on a query to the interactive geometric node.

Optionally, the data set can be a digital interaction data. The data set can be biometric data from a biosensor. The data set comprises a previous result of another interactive geometric node. The results from the interactive geometric node can be a geometric representation, a geometric computation or a geometric decision.

### BRIEF DESCRIPTION OF THE DRAWINGS

The present application can be best understood by reference to the following description taken in conjunction with the accompanying figures, in which like parts may be referred to by like numerals.

FIG. 1 depicts, in block diagram format, a process of geometric representations, use and decisioning of data, according to some embodiments,

FIG. 2 depicts, in block format, an example system for implementing process 100 and various use cases described herein.

FIG. 3 depicts a computing system with a number of components that can be used to perform any of the processes described herein.

FIG. 4 depicts an exemplary computing system that can be configured to perform the processes provided herein.

FIG. 5 depicts, in block diagram format, a process of geometric representations, use and decisioning of data, according to some embodiments.

The Figures described above are a representative set, and are not an exhaustive with respect to embodying the invention.

### DETAILED DESCRIPTION

Disclosed are a system; method, and article of manufacture for interactive geometric representation, use and decisioning of systemic epidemiological data. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to hunt the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Process

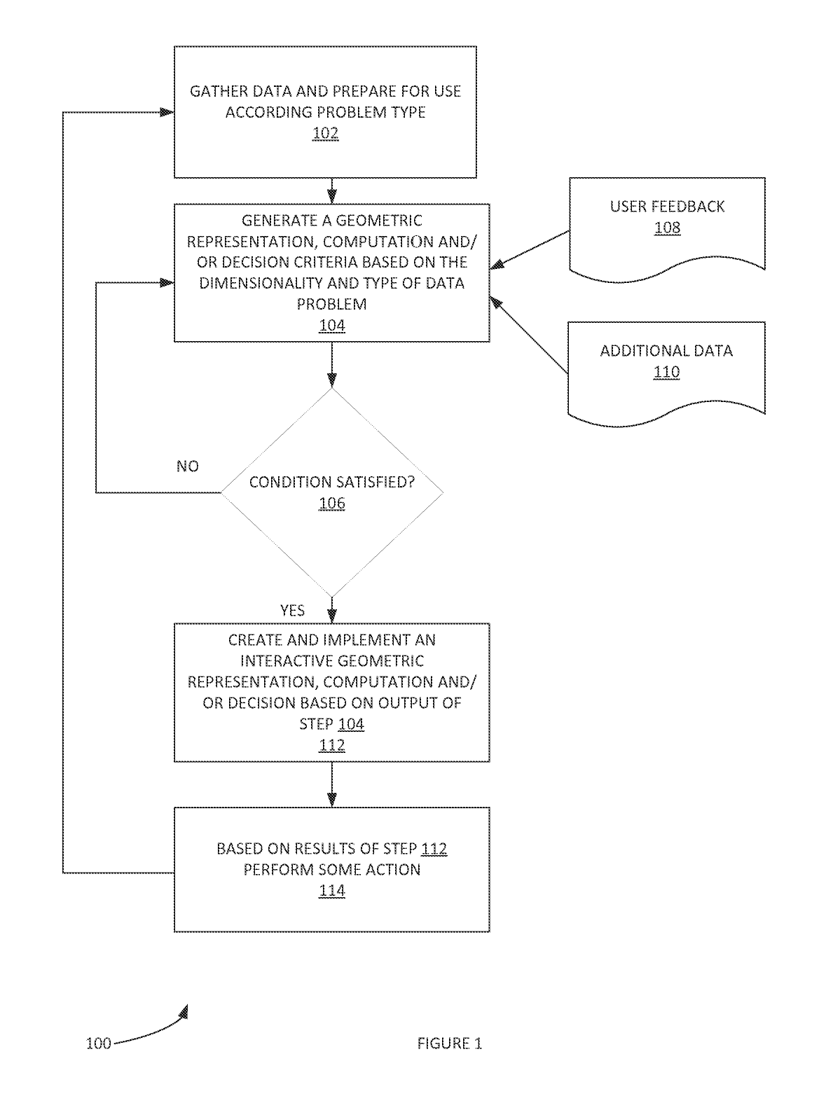

FIG. 1 depicts, in block diagram format, a process 100 of geometric representations, use and decisioning of data, according to some embodiments. In step 102 of process 100, the data is gathered and prepared for use according to data type and problem type. The data source can be structured or unstructured data sets. Exemplary data sources can include, inter alia, financial data (e.g. tick data), health data (e.g. biometric data), news/political data (e.g. news source data feeds), social data (e.g. social network data, inter-user interaction, data, social commentary, etc.), ecological/nature data (e.g. geographic/weather data like temperature, wind velocity, pollen count, etc.), a combination of heterogeneous data and the like. It is noted that, in some example embodiments, data sources can include type of data used in the example use cases provided infra, it is also noted that data source can include previously generated geometric representations of data, data usage, user feedback and problem statements for further analysis, representation and use. In addition, data from a data feed can be obtained, stored, filtered, parsed, categorized and the like. The data can be formatted with a markup language (e.g. a set of rules for encoding, data in a format that is both human-readable and machine-readable such as an XML format). It is noted that in one example embodiment, a markup language can be developed and/or selected based on various attributes of the data and/or data source. In one example, a snapshot of data from data source can be obtained, tagged with XML (or an XML-like markup language) and stored in a database. The data can be tagged with any tags deemed appropriate for the particular data attributes (e.g., time stamps, location information, data type, data source, etc.). Tags can be indexed and/or sorted according to an indexing scheme. Optionally, a list of indexed and sorted tags and meta-tags can be generated. An administrator can specify any knowledge-hierarchy and/or knowledge-topology, tag-meta tag relationship, importance, weighting rank, storage criteria, axis (e.g., coordinate, radial), scale, sequence and/or data source to be included in the list. The list can itself include a set of lists or arrays with list elements.

In step 104 of process 100, a geometric representation, use and/or decision criteria can be generated based on the geometric attributes, properties, predicates and operations of the data and data problem(s) presented by the output of process 102. Step 104 can utilize the output of step 102. A geometric representation can be an arrangement or configuration or composite of a plurality of primitives (such as a point or vertex) such that the relations between primitives can be specified as properties (such as angles, distances etc.). In addition, properties of the composite representation (such as boundary, volume etc.) can be derived from configuration properties of the primitives relative to each other. In addition, measures (such as area) on the properties can be computed; predicates (such as maximum area) can be specified, operations (such as division based on maximum area) can be performed. A geometric use can include using a geometric representation to understand the configuration of geometric primitives such as how points are distributed relative to each other and use this understanding for possible further action. For example, points located on the vertices of an equilateral triangle and points located on the vertices of a scalene triangle can have different relative configurations. A geometric decision criteria can include a condition where the criteria may be dependent on some explicit, implied and/or computable property of a geometric object and/or primitive. The property could relate primitives to each other or describe the composite geometric object. One or more geometric representations, uses and/or decisions criteria (and/or decisions, see step 112) can be included, in a geometric node. In this way, results from a geometric node can be a composite of these elements.

In one example, step 104 can implement an iterative sequence of geometric operations such as going from a low dimension to high dimension representation of the data from step 102. For example, step 104 can include substeps that convert one node (vertex) to a line to a triangle, and/or a ‘simplicial complex’ (e.g. a polyhedron). It can be determined where the borders of the simplexes are, which vertices to delete and which vertices to maintain. As necessary, additional computations such as computation of cycles of actions, factoring, out sub-spaces, creating composites of sub-spaces, creating sequences of relevant mappings can be implemented. The appropriate geometric computations on the aggregate geometric node (and/or elements thereof) can also be computed.

In step 106, it can be determined whether a specified condition about the output of step 104 has been satisfied. For example, a condition can be user specified (e.g. a query to the user such as “are you happy with this representation” and/or “choose one of these five geometric representations”, etc.). A condition can be an algorithm/problem complexity metric. This can be a geometric representation problem that can be solved in a reasonable time period before the user gets bored and shuts down the application. In another example, the condition can be memory determined. For example, the condition can be some action that a geometric representation may allow a user of a computing device to perform. If the condition is not satisfied (e.g. a ‘no’ result in process 100) then process 100 can return to step 104. It is noted that additional user input 108 and additional data 110 can be included at this time into step 104 in order to provide a modified output of step 104 in each subsequent iteration until condition 106 is satisfied. If the condition is satisfied (e.g. a ‘yes’ result in process 100) then process 100 can proceed to step 112. It is noted that, in some example embodiments, the condition can be based on the complexity of the problem the geometric node is designed to solve and/or various timeframe/source/system constraints applied to the geometric node. In this way, an iterative loop can be included in process 100 whereby the output of the geometric node undergoes various degrees of refinement. An updated version of the results of the geometric node can be developed based on such inputs as user feedback or additional data (e.g. updated data from the data source). A mechanism can be provided for process 100 to interact with a user and solicit, feedback with respect to the attributes of the geometric node. Data of user interaction can be stored in the geometric node for future analysis and use. The final version of the output of the geometric node output of step 104 can be a composite of one or more alternate sub-representations.

In step 112 of process 100, an interactive geometric node (e.g. can include one or more geometric representations, uses and/or decisions) can be created and implemented based on output of step 104. In step 112, the geometric node can be provided with a conditional logic allowing it to interact with queries provided by other nodes in a network. For example, when prompted by a query, the geometric node can check for one or multiple specified conditions. For example, the output of an interaction with the geometric node can be a simple [1,0] and/or a sequence of ‘Yes, NO’ conditions (e.g. an array with element [1,1,1,1,0,0]) depending, upon the complexity of the conditional question. The results of the geometric node as well as the conditional check based on the results are available for storage, messaging and query. The data involved in step 112 is again amenable to storage and query anywhere in a network.

It is noted that each geometric node can retain a memory of the type of problem the parameters, the volume, the geometric, approach, the algorithms, the outcome of its implementation, etc. The next time a similar problem is presented to the geometric node, a search of its memory repository (as well as possibly other search sources) to see if the data type, problem type, volume type (and the like) have been previously encountered. Corresponding implementations and outcomes can then be analyzed for reuse.

In step 114, a specified action can be performed by a computing system based on the results (e.g. the generated results of the geometric node and/or queries addressed to the geometric node). For example, the geometric node can initiate a search operation. In another example, the results of the geometric node can be made available to join a network and be queried.

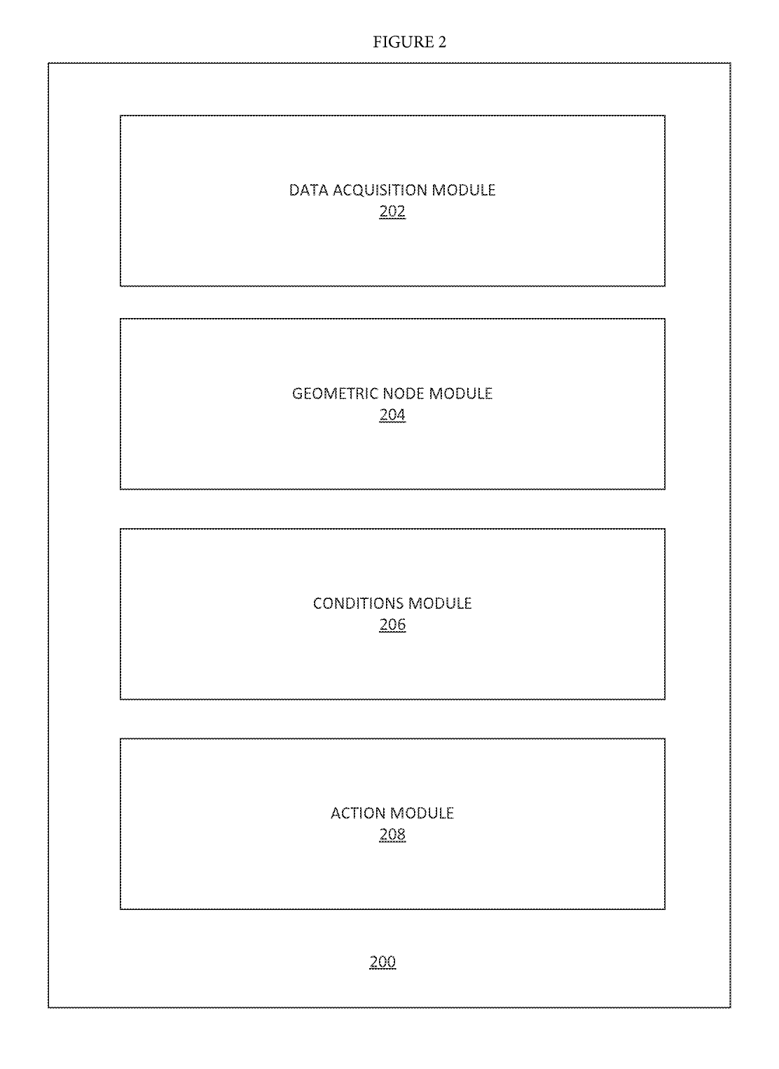

FIG. 2 depicts, in block format, an example system 200 for implementing process 100 and various use cases described herein. System 200 can include a data acquisition module 202. Data acquisition module 202 can gather data and prepare for use according, to problem type. Data acquisition module 202 can include submodules and functionalities such as parsers, search engines, sorters, metadata tag, readers and taggers dictionaries, tables to match data sources to data types, etc.

System 200 can include a geometric node module 204. According to various embodiments, geometric node module 204 can represent a space (e.g., as a set of data points) through appropriate geometric primitives, constructions and/or objects (such as vertices, lines, triangles). Geometric node module 204 can specify attributes of the geometric primitives, constructions and/or objects. Geometric node module 204 can develop appropriate metrics of raw, intermediate and/or composite constructions, objects and/or primitives. Geometric node module 204 can develop predicates based on the specified attributes and/or properties and/or metrics. Geometric node module 204 can operate on geometric objects, constructions and/or primitives based on (an iterated or sequenced or weighted or otherwise prioritized) set of predicates. Geometric node module 204 can recommend decisions based on the results of operations, predicates and/or attributes. Geometric node module 204 can retain a memory of the above for future geometric analysis.

Various example implementations of geometric node module 204 operations are now, provided in one example, geometric node module 204 can represent a space (e.g. a set of data points) through appropriate geometric primitives, constructions and/or objects (such as vertices, lines, triangles). The purpose of a geometric construct can be to represent and/or encode geometric primitives and/or components (e.g. a fundamental geometric object such as a point) and in relation to itself and others in the data set to which it belongs. Examples of distinct components of a geometric object can be, inter alia: vertices, facets, edges, and the like. An example of a geometric construction can be an incidence matrix. An incidence matrix can represent the facets and vertices of a one or more geometric objects in relation to each other. A geometric construct can include different versions, for example, differing in row/column permutations but otherwise representing the same geometric object. A geometric construct and/or object can represent different underlying data points. The underlying data point can be real numbers, rational numbers and the like. Examples of other geometric objects can include vectors, hyperplanes, triangles, cubes, ellipses, ellipsoids, spheres, polyominoes, etc.

Geometric node module 204 can specify attributes of geometric primitives, constructions and/or objects. Attributes may be labeled or unlabeled. Geometric constructions and/or objects can have properties that can he specified, computed or studied in other manner. Examples of attributes and properties can include, inter alia: angles, symmetry, boundedness, polarity, vertex order and/or ranking (e.g. based on some attribute).

Geometric node module 204 can develop appropriate metrics of raw, intermediate and/or composite constructions, objects and/or primitives. For example, the properties and attributes of a geometric construct and/or object can be studied and measured with appropriately developed metrics. Attributes may be labeled or unlabeled. Examples of metrics can include, inter alia: number of vertices, number of edges, number of faces, area, perimeter, volume, surface area, angle, radius, spread, density, distance (e.g. in various forms such as a geodesic, power distance: skew, convex, link, separation, Hausdorff and the like), vertex path, etc. The error/complexity of implementing, rendering, computing geometric constructs through different algorithms can also be measured and specified.

Geometric node module 204 can develop predicates based on the specified attributes and/or properties. The properties and/or attributes of a geometric construct can be chosen, ordered, ranked, sequenced or in any other form selected or highlighted based on predicates in which certain type of logic and/or reasoning can be embedded. Examples of predicates can be, inter alia: checks for equality or inequality of an attribute, checks for consistency, monotonicity, periodicity, intersection, (local or global) minimum/maximum/optimized (e.g. angles, path/cycles, distance time, cost, etc.), sequence/order specification, range/interval, sign(positive/negative or absolute value), ranking/weighting criteria, uniqueness criteria, critical point Predicates may be Boolean, exact and/or approximate. In addition, they may be hierarchical, layered, weighted, conditional or a composite of other predicates.

Geometric node module 204 can operate on geometric objects, constructions and/or primitives, operations can be categorized and accessed individually or as part of family of operations. Operations can be performed on a geometric object and/or constructions. For the purposes of the operation, attributes, properties, metrics, predicates of the geometric object and/or construction may be referenced. These may reflect the original configuration of the object and may in some form re-configure or in some other form morph or transform the geometric object. The original geometric object, the operation that changed it as well as the new object can be stored in memory and accessed anywhere in the network.

Examples of Operations can be, inter alia: division/separation/removing geometric objects and/or primitives. Examples of division can include, inter alia: dividing based on same object (e.g. triangles with a specified predicate), dividing into different types of geometric objects such as a triangle, cube, tetrahedron and/or polytope, division based on shared attribute or property (e.g. distance), division with some predicate and/or attribute combination (e.g. at most/at least K vertices, packing/volume, distance, or spread).

Geometric node module 204 can connect geometric objects and/or primitives. Example of connection operations include, inter alias connecting a set of the same object into a composite (e.g., triangles with a specified predicate), connecting different types of geometric objects into a composite triangle, cube, tetrahedron, polytope, connecting based on shared attribute and/or property (e.g. adjacency, distance, proximity), connecting with some predicate and/or attribute combination (e.g. at least K vertices, packing/volume, distance, or spread).

Geometric node module 204 can perform intersections or check for co-incidence, degree of intersection or lack of intersection. It can bring together more than one similar and/or different geometric object so they are not necessarily co-incident. If objects are co-incident then the configuration and location of all of the geometric primitives can be specified in one set. Example intersection operations can include, inter alia: intersecting halts-spaces, circles.

Geometric node module 204 can perform other operations such as, inter alia: developing a boundary/perimeter (e.g. convex hull of points), develop an ordering (e.g. lexicographic ordering of vertices), develop a trajectory/path (e.g., a path of vertices of a cube), develop a grouping (e.g. a grouping of geometric objects b properties such as reflection or symmetry), develop a weighting (e.g. by indices or metrics), check for further reducibility/irreducibility, develop a randomization/derandomization (e.g. geometrically-defined random behavior; probability of events specified by random geometric configurations, etc.). The operations can include, inter alia: one-time operations, repeated operations, weighted operations, hierarchical operations, multi-level operations, recursive operations, labeled/non-labeled operations, etc. All of the intermediate or final results of the geometric node: properties, predicates, metrics, operations, representations may be available for use and query.

Geometric node module 204 can recommend decisions based on results of operations, predicates or attributes. Attributes, properties and/or predicates of the geometric object (e.g. as represented by original data or reconfigured through operations) can be used to make a decision. Examples of decisions can be, inter alia: optimization (e.g. arriving at a feasible set given geometrically defined constraints), sequencing (e.g. arriving at a sequence of geometric primitives, objects and/or constructions that fulfill properties and/or predicate-defined criteria), and search (e.g. searching for geometric, primitives, objects or constructions that fulfill properties and/or predicate-defined criteria. Decisions can also include a composite of other decisions. Geometric node module 204 can retain a memory of past operations, decisions and representations for future geometric operations.

Conditions module 206 can implement some conditional logic based on the outputs of geometric node module 204. This module can be amenable to storage, messaging and query anywhere in a network. Action module 208 can perform a specified action can be performed by a computing system based on the results (e.g. the generated results of the geometric node and/or queries addressed to the geometric node). System 200 can be combined with the various other functionalities described herein to perform process 100 as well as any additional use cases.

Several example use cases of process 100 are now provided. In one example use case, a large scale data (e.g. foreign exchange data—AUS/USD 60,000 ticks/day) can be received. It can be determined whether the system has previously addressed this type (foreign exchange data) and/or volume (60,000 ticks) of data. Actions can be performed based on the geometric node. Alternate geometric representations can be determined based on data, data attributes, propenes, error/precision level, predicates, operations computations, problem needs etc. For example, computations on or more triangulations of data points can be performed based on data attributes such as density, price distance, etc. Geometric object (triangulation) operations can be performed by intersecting it with geometric attributes of constraints (e.g. existing trade positions, maximum price risk and projected geometric attributes of the next days trades and perhaps user specified preferences). Based on these attributes and constraints, a geometric optimization object can be specified and made available anywhere in the network. A set of trade recommendations can be made based on the geometric object. Conditions can be checked. An example of a condition can include the value of a profit from a trade. Optionally, the metric can be user-specified. Based on condition, the process can continue to recommend or work through step 104 of process again to make another decision based on additional data/user feedback. Some action can be performed. For example, retains memory of problem and approach for future geometric analysis.

In another example use case, process 100 can be utilized in search methodologies such as with large scale datasets and/or local datasets. A geometric search object can be created. The geometric search object can represent search object with appropriate representation of the object's type/primitives, attributes, predicates, and/or metrics and/or operations. Attributes of the geometric search object can be available to be saved and shared anywhere in a network. The geometric search object can be available for further analysis or re-configuration under geometric operations. Examples of data that the search can include, inter alia: economic data, digital footprint data, environment data, biometric and/or ecosystem data. Examples of economic data can include, inter alia: consumer data (e.g. point of sale data, user behavior, demographic data); supplier data (e.g. supply chain data, manufacturing data, transport/logistics/routing data, sale, revenue, pricing, margins, industrial data); financial data (e.g. prices and other attributes of various instruments in the financial markets such as equity asset prices, foreign exchange prices, interest rates, instrument prices, options prices, asset-backed security prices etc.); and/or macroeconomic data (e.g., unemployment, surveys etc.). Example of digital footprint data can include audio, video, photos, social media (e.g., text, interaction data), travel log, global positioning system (e.g. GPS), kernel, i-node data logs of events on devices (e.g. from application layer down to the network layer). Examples of biometric data can include heart rate, blood, pressure, eye tracking:, brain wave, galvanic skin response data, oxygen levels, cortisol levels, and the like. Examples of environmental data can include GPS, wind, sunshine, carbon footprint. An example of ecosystem data can include bird sound recordings. It is noted that heterogeneous data can be combined for purposes of solving a data problem.

With these diverse and heterogeneous types and sources of data, searches can be performed for certain data elements in a data set. Process 100 can be implemented during a search operation. Data can be received. The data can be from the economic data, digital footprint data, environment data, and/or ecosystem data categories. The data can be prepared for use. For example, the data can be scaled, possible errors can be identified and corrected, etc. Acceptable tolerances of error/time can be identified. Actions can then be performed based on the results of the geometric node. An underlying data set can be defined. The geometric search object can be defined. The geometric constructions can be defined As described, in the geometric node, geometric representations and/or constructions can be based on data, data attributes, properties, error/precision level, predicates, computations, problem needs etc. For example, the geometric search object can be represented as: a circle with seine notion of distance/radius; a triangle with some order/relation of vertices; a rectangle with some uniqueness criteria and/or hierarchs, weight. An algorithm (e.g. among a library of several embedded in the geometric node) can be chosen. Optionally, alternative algorithms can also be selected to construct and operate on geometric search object. The underlying data set (raw or prepared previously) can be traversed by geometric operations. Example geometric operations can include, inter alia: grouping/dividing the data set (by attributes/properties and/or any geometric search objects found); weighing/recalibrating data sub-set based on geometric search objects located or not located; mapping trajectory path of geometric search object in data set; and/or iterating/recursively performing geometric operations. Next, conditions can be checked. For example, it can be determined whether geometric search objects were found with acceptable levels of error and in acceptable time or steps. If not, then an appropriate previous step(s) can be performed again (possibly including additional data or user feedback). If the condition is satisfied, then the process can continue.

Next, an output such as a representation and/or computation can be provided. Examples can include a geometric representation/construction of the underlying data set, the geometric search object, alternate implementations of geometric algorithms performing geometric operations, computations/metrics/attributes/predicates of the geometric search object etc. Based on this output, various operations can be performed. For example, a message that includes these outputs can be sent throughout the network and/or to specific entity in the network A message can be sent to some entity in the network to perform some action. Geometric computations/attributes can be sent to a 3-D printer, or an apparatus that manipulates matter at an atomic or molecular level (e.g. nanoscale machines/MEMs). Geometric computations/attributes can be sent to an augmented reality system. A message can be sent to a high priority receiver and/or action item entity such as law enforcement. A memory of problem and approach can be retained for future geometric analysis.

In another example use case, process 100 can be utilized to render decisions with multiple dependencies and that may intersect with the decisioning process of other individuals or groups. Example decisions of this type can include, inter alia: healthy eating choices; paths of marginal decisions (e.g. travel, budget, social interaction) decisions for a period, of time; sequences of individual and/or collective marginal (and in some cases globally-consequential) decisions. Geometric nodes and methodologies (e.g. process 100) can be used to analyze, represent and develop these decisions. For example, individual and/or collective decisions can be geometrically represented and/or sequenced. In another example, a decision hierarchy and/or weighting scheme can be developed.

Taking process 100 as a template, in a first step, decision data can be received. Underlying decision space can be defined geometrically. This can include, for example (one or more) decision objects, outcome objects, and/or decision sequencing objects geometrically. Examples of data types that can be used to create a decision object include, inter alia: health/biometric data (e.g. heart rate, blood pressure etc.); travel and/or location data (e.g. GPS, change in coordinates): time data (e.g. absolute and/or relative time). The decision space can be prepared for later use. For example, it can be scaled, possible errors can be identified and corrected, etc. Acceptable tolerances for errors and time can be obtained.

Actions can be performed based on the results of the geometric node. For example, the results of the data gathering step can be retained and/or modified. The underlying decision space (e.g. as a combination of underlying data and/or variables) can be defined in geometric terms. The decision object and outcome object can be defined as geometric constructions. As described in with regards to geometric node module 204: these representations and/or constructions can be based on data, data attributes, properties, precision level, error level, predicates, computations, problem needs, etc. For example, the geometric decision and outcome objects can be represented as: a circle with a defined distance and radius, a triangle with a relation of vertices, a rectangle with a uniqueness criteria, and/or hierarchy weight. A sequencing of objects can be represented as: vertex sets, incidence matrices etc. An algorithm (e.g. from a library of several embedded in the geometric node) can be chosen to construct a geometric decision, outcome or sequence of objects. The underlying decision space can be traversed by geometric operations. Example geometric operations that can be implemented in this context include: measure an outcome object; iterate through the decision space, develop alternate sequences, develop a trajectory of decisions to outcome; develop a boundary (e.g. a convex bull of outcome points): develop a trajectory (e.g. a path of vertices from decision to outcome); develop a weighting and/or recalibration (e.g. weighting or hierarchy of outcomes by indices or metrics); develop a randomization/derandomization of decision and outcome objects (e.g. geometrically-defined random behavior; grouping decision space (e.g. by attributes of decision and outcome objects found); and/or iterating or recursively performing geometric operations.

In another example use case, a combination of geometrically defined objects can be used. For example, a combination of an optimization, search, decision and outcome object can be created. For example, a text search (a geometrically defined search object) can be combined with a biometric search (another geometrically defined search object) to create a geometric text-biometric search object. This sort of search object may provide a way to analyze and query text data alongside measured human responses to the text data. The characteristics (properties, metrics, predicates, operations) of the combined object are accessible throughout the network and are amenable to further refinement In another example, a biometric optimization object can be combined with a geographic path-sequencing object to create a biometric/geographic optimization/sequencing object which may be used to create a biometric overlay over geospatial data. Again, the characteristics (properties, metrics, predicates, operations) of the combined object are accessible throughout the network and are amenable to further refinement.

Next, a condition can be checked. An example of a condition can include determining whether a path or trajectory from a decision object to an outcome object has been found with acceptable level of error and in acceptable time or steps. If the condition has not been satisfied then previous steps can be performed again, as well as additional steps, such as obtaining additional data or user feedback.

If the condition is satisfied then the process can continue to provide a representation of the computation. Example representations of the computation can include, inter alia: geometric representation/construction of the underlying decision space, the decision/outcome, sequencing objects, alternate implementations of geometric algorithms performing geometric operations, computations/metrics/attributes/predicates of the geometric decision/outcome etc.

Further actions can be performed based on the output of the representation of the computation. A message that includes the output of the representation of the computation can be sent throughout the network or to specific entity in the network. A message can be sent to some entity in the network to perform some action (e.g. animate, report paths). Examples of actions include inter alia: sending geometric computations, sending, geometric attributes to a 3-D printer or a device for manipulation of matter at an atomic or molecular level (e.g. nanoscale machines/MEMs); sending geometric computations and/or attributes to an augmented reality system; sending a message to a high priority receiver/action item entity such as law enforcement and the like: retain memory of problem and approach for future geometric analysis.

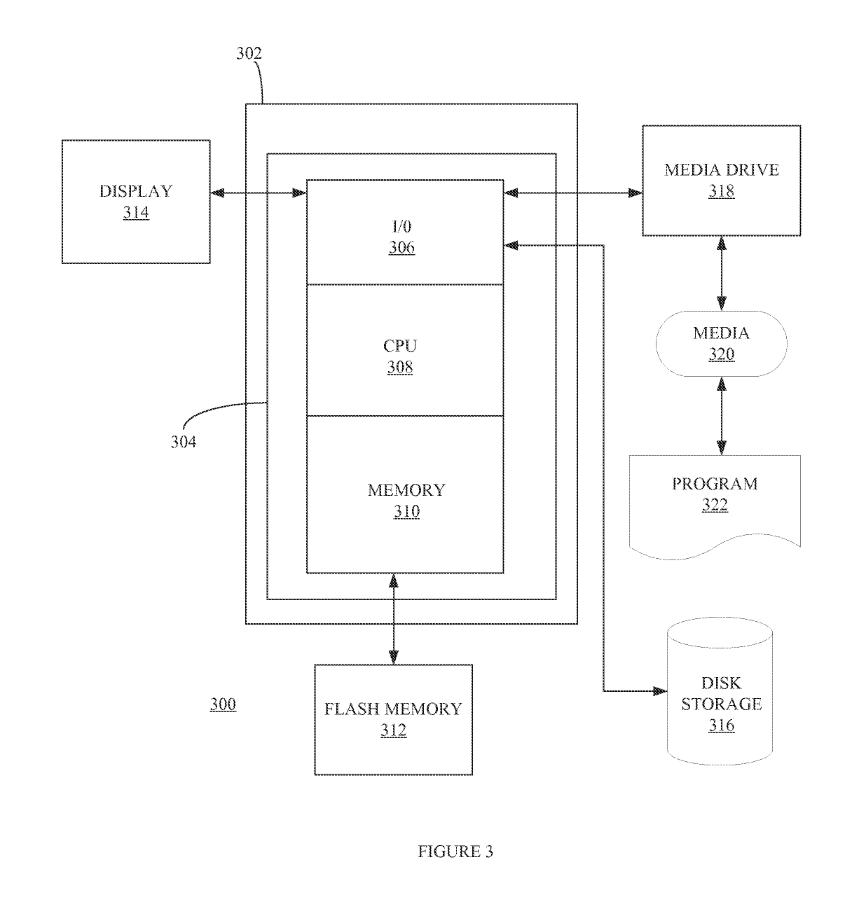

FIG. 3 depicts an exemplary computing system 300 that can be configured to perform several of the processes provided herein, in this context, computing system 300 can include, for example, a processor, memory, storage, and I/O devices (e.g., monitor, keyboard, disk drive. Internet connection, cloud, virtual, distributed network, data center, etc.). However, computing system 300 can include circuitry or other specialized hardware fur carrying out some or all aspects of the processes. In some operational settings, computing system 300 can be configured as a system that includes one or more units, each of which is configured to carry out some aspects of the processes either in software, hardware, or some combination thereof.

FIG. 3 depicts a computing system 300 with a number of components that can be used to perform any of the processes described herein. The main system 302 includes a motherboard 304 having an 110 section 306, one or more central processing units (CPU) 308, and a memory section 310, which can have a flash memory card 312 related to it. The I/O section 306 can be connected to a display 314, a keyboard and/or other attendee input (not shown), a disk storage unit 316, and a media drive unit 318. The media drive unit 318 can read/write a computer-readable medium 320, which can include programs 322 and/or data. Computing system 300 can include a web browser. Moreover, it is noted that computing system 300 can be configured to include additional systems in order to fulfill various functionalities. Display 314 can include a touch-screen system. In some embodiments, system 300 can be included in and/or be utilized by the various systems and/or methods described herein.

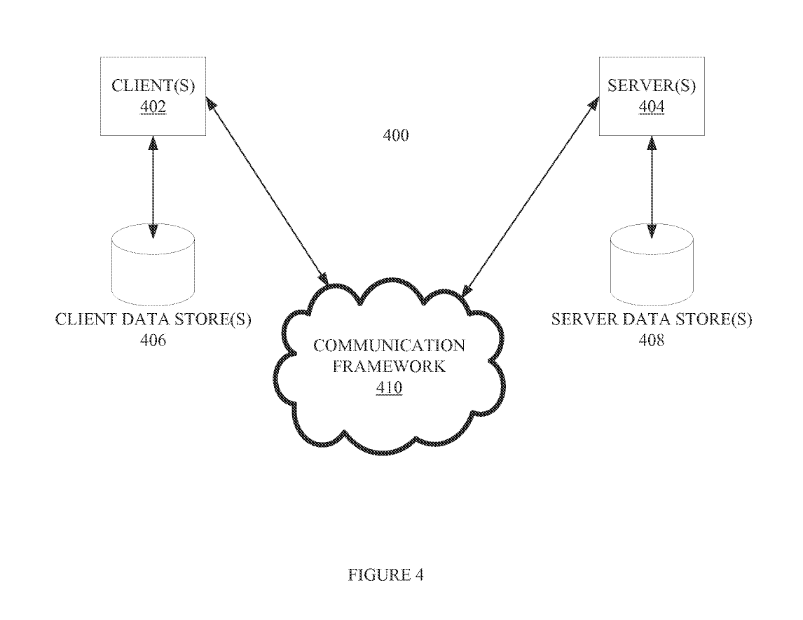

FIG. 4 is a block diagram of a sample computing environment 400 that can be utilized to implement some embodiments. The system 400 further illustrates a system that includes one or more client(s) 402. The client(s) 402 can be hardware and/or software (e.g., threads, processes, computing devices). The system 400 also includes one or more server(s) 404. The server(s) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be employed to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404. In some embodiments, system 400 can be included and/or be utilized by the various systems and/or methods described herein to implement processes described herein such as process 100 as well as any process as provided herein.

At least some values based on the results of the above-described processes can be saved for subsequent use. Additionally, a (e.g. non-transients) computer-readable medium can be used to store (e.g., tangibly embody) one or more computer programs for performing any one of the above-described processes by means of a computer. The computer program may be written, for example, in a general-purpose programming language (e.g., Pascal, C, C++, Java, Python) and/or some specialized application-specific language (PHP, Java Script, XML).

An important problem where large scale systems dynamics is relevant is epidemiology. Understanding and forecasting disease, infection and mortality rates may be a problem of large scale system dynamics. An example of a contemporary epidemiological technology is OpenEpi. OpenEpi used for epidemiology, biostatistics, public health and medicine. OpenEpi computes statistics for counts and measurements in descriptive and analytic studies, stratified analysis with exact confidence limits, matched pair and person-time analysis, sample size and power calculations, random numbers, sensitivity, specificity and other evaluation statistics. R×C tables, chi-square for dose-response, and links to other useful sites.

Polyhedral node applications can be used to characterize the geometric, dynamics of large scale systems. A tool is used for large scale for epidemiology and public health. The input can gathers data about the disease state—infection rates, mortality rates, locations, time etc. In one example methodology the following steps can be utilized. Geometric objects can be developed. These geometric objects can represent disease data geometrically. For example, a death can be represented as a vertex of a geometric object. The process can perform operations on determined geometric objects-such as convex polyhedral—to characterize the current state as well as future state of the disease. Geometric operations and intermediate computations such as eigenvalues can be computed. Geometric conditions on the stochastic evolution/transition/reversibility/irreverability/arrival time waiting times/phase dynamics of the states can be imposed. Geometrically characterized Markov chains—geometric/combinatorial objects—can be used as well. State transition probabilities can be represented as matrixes, computed and studied. Evolution of the Markov Chain can be characterized by Differential Geometry. Different geometric properties of the vertex sets can be studied. Limiting distributions/rate of convergence can be computed and studied. Understanding of stochastic dynamics on manifold structure can be employed. Understanding the global behavior and transition points can be employed. Accordingly, the following output can be provided. Geometric objects, predicates and operations can be used to arrive at probability—disease state, infection, recovery, expected death rate, understanding of disease states, disease dynamics, etc. A distribution of medical health waiting, times, patient queues, phase transitions, etc. can also be determined.

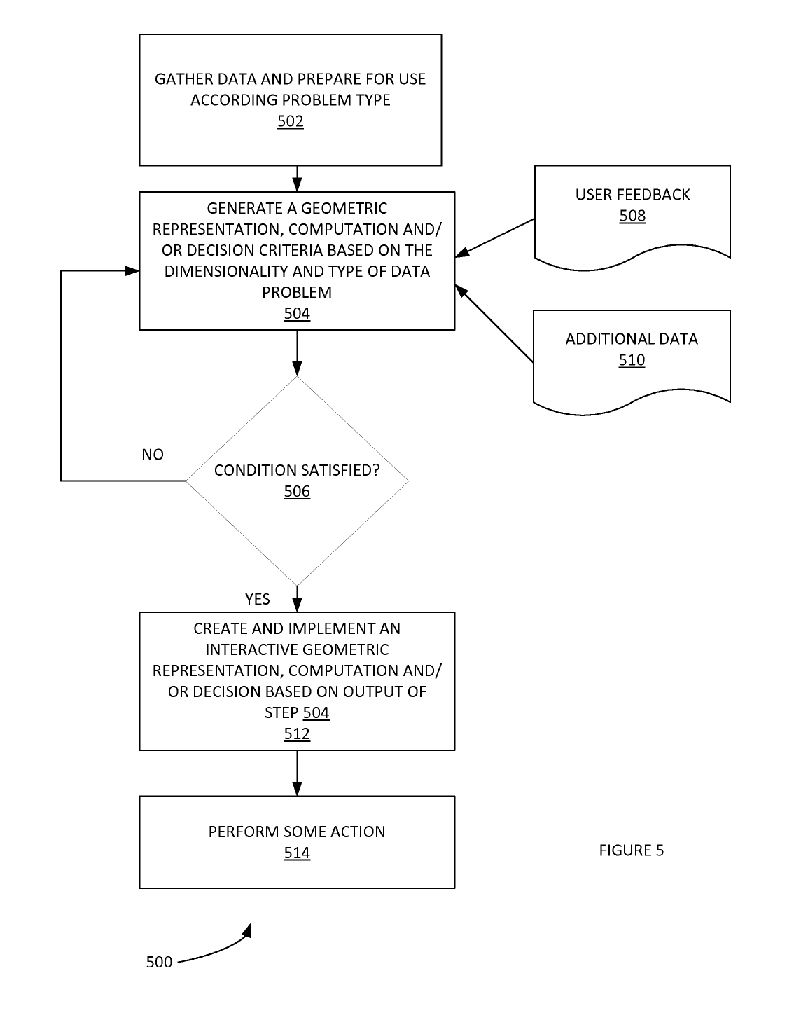

FIG. 5 depicts, in block diagram format, a process 500 of geometric representations, use and decisioning of data, according to some embodiments. In step 502 of process 500 data is gathered and prepared for use according to problem type. Examples of data received can be biometric, geographic, temporal, spatial, demographic data regarding infection and recovery of individuals in a population. This data can he stored and beneficially accessed in a real time system. In step 504, a geometric representation, computation and/or decision criteria based on the dimensionality and type of data problem can be generated. This data can be represented as discrete stages—such as susceptible, infected or deceased. The stage data can be collected at discrete time states—time=0, 1, 2 etc. The combination of stage and state data can be represented as a matrix. The rows of this matrix can represent the stage index of a process (Susceptible infected, Dead) and the columns reflect the state index (Time=0, 1, 2)Probability of moving from Stage i to another Stage j in one Time Step is called Transition Probability. Similarly the n-step Transition Probability can be computed. We can assume that Transition Probabilities are Stationary, or independent of when the transition occurs. Transitions from one stage to another stage can be computed. Stochastic dynamics at the individual level can be described and population inferences can be made. Geometric approaches to Markov Chains provide a convenient approach to study the dynamics of a system, especially in high-dimension spaces. Conditions such as the dependence of one state on the previous time state alone, i.e. the Markov condition, can be imposed. The Geometric properties of the Markov Chain Matrix can be studied. For example, the total number of vertices, triangular regions can be studied. Geometric properties such as dimension, volume and eigenvalues can be related to the convergence rate of probabilities and properties such as stationarity. Based on the above analysis. Infection and Recovery Probability Rates, Cumulative Probabilities, Expected Infection Duration, Expected Life Expectancy and Population Incidence Rates can be computed.

If ‘yes’, then in step 508, user feedback can be provided. The user can provide feedback if the all the data has been incorporated or additional data is available to be included in the geometric representation and calculations. In step 510, additional data can be obtained. Additional data can be included in the system as it becomes available. In step 512, process 500 can create, implement interactive geometric representation, computation and/or decision based on output of 504. As the probabilities in step 504 are arrived at decisions can be made. For example, if certain geographic locations have high population incidence rates or that have incidence rates that have crossed certain thresholds, resources can be allocated accordingly. In Step 514, some action can be performed. As discussed above, based on the results of the geometric node, some action can be performed. For example, result of a high population incidence rate can be broadcast on a social media network.

An example of a contemporary epidemiological technology is OpenEpi. OpenEpi can be used by researchers to study epidemiology, biostatistics, public health and medicine. OpenEpi can compute statistics for counts and measurements in descriptive and analytic studies, stratified analysis with exact confidence limits, matched pair and person-time analysis, sample size and power calculations, random numbers, sensitivity, specificity and other evaluation statistics, R×C tables, chi-square for dose-response, and links to other useful sites. In one embodiment, process 500 can be used to characterize the geometric dynamics of large-scale systems. Process 500 can gather data about the disease state—infection rates, mortality rates, locations, time etc. Process 500 can represent disease data as geometric objects. Process 500 can develop geometrically characterized Markov Chains—geometric/combinatorial objects. For example, a death can be represented as a vertex of a geometric object such as a polyhedral. Process 500 can represent, study and computed State transition probabilities. Process 500 can perform operations on the geometric object to characterize the current state as well as future state of the disease. Process 500 can perform computations such as eigenvalue and matrix computations. Process 500 can impose conditions on the stochastic evolution/transition/reversibility/irreversibility/arrival time/waiting times/phase dynamics of the states, periodicity and connectedness of the matrix and other Differential Geometric attributes. Limiting distributions rate of convergence can be computed and studied. Understanding of stochastic dynamics on manifold structure is employed. Understanding the global behavior and transition points can be employed.

Process 500 can use the above stated geometric objects, predicates and operations to arrive at an understanding of disease dynamics—probability of disease state, infection, recovery, expected death rates, waiting times, patient queues, phase transitions. Process 500 can further use this understanding of disease dynamics to take an action—such as publishing, the results on a social network, or making appropriate resource allocation decisions to the group determined to have the highest disease risk.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-4 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited, to, application specific integrated circuits (“ASICs”) or field programmable gate array (“FPGAs”). Storage devices suitable for tangibly embodying program instructions include, but are no limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A computer-implemented method comprising:
obtaining a data set from a data source;
preparing the data set for an analysis operation according to a problem type;
generating a result from an interactive geometric node based a geometric property of the data set; and
determining a specified condition with the result from the interactive geometric node based on a query to the interactive geometric node.

2. The computer-implemented method of claim 1, wherein the data set comprises a digital interaction data.

3. The computer-implemented method of claim 1, wherein the data set comprises biometric data from a biosensor.

4. The computer-implemented method of claim 1, wherein the data set comprises a previous result of another interactive geometric node.

5. The computer-implemented method of claim 1 further comprising:
updating a version of the result of the geometric node based on a user feedback or an additional data.

6. The computer-implemented method of claim 1 further comprising:
providing the result of a geometric node's response to the query to a network entity.

7. The computer-implemented method of claim 1, wherein the results from interactive geometric node comprises a geometric representation, a geometric computation or a geometric decision.

8. The computer-implemented method of claim 1, wherein the results from the interactive geometric node comprises a geometric attribute, a geometric metric, a geometric predicate or a geometric operation.

9. An apparatus for data analysis and use in a computing environment comprising:
a processor configured to execute instructions;
a memory containing instructions when executed on the processor, causes the processor to perform operations that:
obtain a data set from a data source;
prepare the data set for an analysis operation according to a problem type;
generate a result from an interactive geometric node based a geometric property of the data set; and
determine a specified condition with the result from the interactive geometric node based on a query to the interactive geometric node.

10. The apparatus of claim 9, wherein the data set comprises a digital interaction data.

11. The apparatus of claim 9, wherein the data set comprises biometric data from a biosensor.

12. The apparatus of claim 9, wherein the data set comprises a previous result of another interactive geometric node.

13. The apparatus of claim 9, wherein a version of the result of the geometric node is updated based on a user feedback or an additional data.

14. The apparatus of claim 9, wherein the result of a geometric node's response to the query is provided to a network entity.

15. The apparatus of claim 9, wherein the results from interactive geometric node comprises a geometric representation, a geometric computation or a geometric decision.

16. The apparatus of claim 9, wherein the results from the interactive geometric node comprises a geometric attribute, a geometric metric, a geometric predicate or a geometric operation.
